(19) United States
(12) Patent Application Publication
(10) Pub. No.: US 2012/0036137 A1
(43) Pub. Date: Feb. 9, 2012

(54) METHOD AND SYSTEM FOR PROVIDING ACTIONABLE RELEVANT RECOMMENDATIONS

(75) Inventors: Enaganti Bhaskar NAIDU, Sunnyvale, CA (US); Bharath Kumar YADLA, Sunnyvale, CA (US); Krishna PANYAM, Bangalore (IN); Khanderao Dattatray KAND, San Jose, CA (US)

(73) Assignee: GLOMANTRA INC., Sunnyvale, CA (US)

(21) Appl. No.: 13/020,021

(22) Filed: Feb. 3, 2011

Related U.S. Application Data
(60) Provisional application No. 61/300,840, filed on Feb. 3, 2010.

(51) Int. Cl. G06F 17/30

(52) U.S. Cl. 707/748; 707/755; 707/E17.084; 707/E17.137

(57) ABSTRACT

A method, a system and a computer program product for providing one or more actionable recommendations relevant to a need of a user and relevant to the user, are provided. A query is received for capturing the need of the user. Further, the need is analyzed to determine one or more characteristics corresponding to the need. Furthermore, the need is processed to generate one or more actionable recommendations. Moreover, the one or more actionable recommendations are provided to the user. The system also includes a processing module to process the need to generate one or more actionable recommendations. The system further includes a feedback module for iterative processing of the need.

### REFERENCE TO PRIORITY APPLICATION

This application claims priority from U.S. Provisional Application Ser. No. 61/300,840 filed Feb. 3, 2010, entitled “Providing relevant recommendations for user needs using Active Relevance”, which is incorporated herein by reference in its entirety.

### FIELD

The present invention relates to the field of providing recommendations to a user, and more particularly, to providing a set of actionable recommendations relevant to fulfill a need of the user.

### BACKGROUND

Internet is been widely utilized by users all over the world in order to search information associated with various fields. Information may be obtained in response to a query provided by a user. Upon providing the query, one or more recommendations in response to the query are provided to the user. The one or more recommendations can be regarded as, in one example, hypertext links that may be browsed by the user.

Conventionally, users utilize various search tools to resolve their queries corresponding to various fields. Such search tools include generic web search engines and various web sites. Further, users utilize specific search engine and specific web site separately to get the recommendations corresponding to his/her query. For example, a user may utilize the web search engines such as Google and Yahoo to gather any information corresponding to his/her need. Also, users typically utilize various websites, such as ‘about.com’, ‘answers.yahoo.com’, Wikipedia.org, and ‘yelp.com’ to corresponding to their specific needs. For example, if the user is willing to receive expert's advice on specific topic then the user may use ‘about.com’ and to get advice for general public, the user may use different website such as ‘answer.yaho.com’. Such ways of utilizing different search tools for searching information/recommendations corresponding to the user's need may consume the user's time and effort in switching from one search tool to another search tool based on the type of the user's need.

Also, searching, performed through such tools, is based just on keywords present in the query that represents the need of the user. Due to this, number of recommendations obtained through such searches is typically large. Further, the obtained recommendations also include stale and irrelevant information with respect to the need of the user. Hence, the user is required to identify relevant information associated with the need from such large number of recommendations. Further, the user may not be sure if the recommendations that are obtained have any relevant recommendation, until all the obtained recommendations are checked by the user. Such tasks of searching and manual identifying the relevant recommendations (information) consume a significant time of the user.

In some cases, the user may not be able to write the query properly to represent the need. In such cases, the user may not receive any relevant recommendation at all. This may require the user to opt trial and error method, for random search, to obtain any relevant information corresponding to the need. When the user does trial and error and resubmits the user requests, the search tools treat each of the requests independent of each other and do not infer the user intention. In such hit and trial method, if the user does not find proper information from search results then the user needs to modified and resubmit the query to check if any suitable result (recommendation) is provided. Due to this, the user is burdened with task of deciding what to type in as the query to specify the need in order to get relevant recommendations. Further, this consumes significant time and effort of the user.

Additionally, if the user gets any relevant recommendation, the user may not get the probable options (additional information) corresponding to the recommendation to fulfill the need of the user. For example, if the user gets a relevant recommendation that provides the name of a particular restaurant corresponding to the need of the user, the user may require obtaining additional information corresponding to that particular restaurant to fulfill his/her need. Additional information, in this example, may include menu, table booking system, restaurant timings and the like. Further, conventionally the user is required to browse through various search tools separately to search the results for relevant recommendations and further required to search additional information corresponding to the relevant recommendation. Such activities to get sufficient information corresponding to the searched result are time and effort consuming.

Typically, the results are viewed on web pages that may provide limited information corresponding to the results. Further, the user may be enabled to perform the only action of clicking the searched results to browse the web pages represented by the results. Thus, the user is required to perform various actions corresponding to the searched recommendations, such as booking a table in a restaurant, ordering meal from the restaurant for home delivery and the like, by taking additional efforts. Thus, typically, conventional ways of providing relevant search results (recommendations) do not provide ways to guide the user to fulfill the need by utilizing the recommendation.

Further, existing are some methods to provide actionable responses that may enable the user to perform the actions (corresponding to the search results) that are more than just clicking the result for browsing. The conventional methods provide the one or more actionable responses by performing search from various recommendation sites. Examples of various recommendation sites include, but not limited to, LibraryThing.com, iLike.com and bizrate.com. Upon providing the search query, the recommendation sites provide results including actions that can be performed in response to the search query. For example, such recommendations web sites may provide a way to the user to buy a book from Amazon, to download a song, or to buy a product from the seller. However, these methods require the user to provide exhaustive list of features, such as the user's tastes and preferences (while querying) to describe the need accurately. Such methods work by comparing the exhaustive list of features (hereinafter referred to as a ‘search query’) provided by the user, with information (such as preferences) of other multiple users. In this, a similarity between the search query and available information of other multiple users is determined. The conventional method may then offer the results (recommendations) based on similarity between the search query and available information corresponding to the other multiple users. However, if similarity between the search query provided by the user and the available information associated with multiple users is not found then the conventional method fails to provide actionable responses to the user.

Thus, conventional methods are lacking in providing general purpose service to provide the user with useful, personalized and relevant recommendations that the user can then act upon to resolve his/her need for a particular situation of the user. The conventional methods return the same results for the same query submitted from the same location and it does not differ based on the user's preferences and context under which the user requesting the information.

In the light of the foregoing discussion, there is a need for an efficient method and system for providing one or more actionable recommendations relevant to needs of the user and to overcome the abovementioned shortcoming in the existing field.

### SUMMARY

To address shortcomings of the prior art, the present invention provides a method, a system and a computer program product for providing one or more actionable recommendations relevant to a need of a user.

An example of a method for providing one or more actionable recommendations relevant to a need of a user includes capturing the need of the user. The need is captured by receiving a query from the user, acquiring user's personal context, situational context, location context and the like. The method also includes analyzing the need to determine one or more characteristics corresponding to the need of the user. The method further includes processing the need to generate one or more actionable recommendations. The need being processed based on at least one of the one or more characteristics. Further, the method includes providing the one or more actionable recommendations relevant to the user for enabling the user to perform one or more actions. The one or more actions corresponding to actionable recommendations. Moreover the method includes enabling the user to provide feedback for the one or more actionable recommendations based on the need of the user. The feedback may be provided by keywords, hints and opinions. The feedback being processed to upgrade the one or more actionable recommendations corresponding to the need of the user. The method also includes enriching the one or more actionable recommendations to obtain value added information and to identifying actions associated with the one or more actionable recommendations.

An example of a method for providing one or more actionable recommendations relevant to a need of a user includes capturing the need of the user. The need is captured by receiving a query from the user. The method also includes analyzing the need to determine one or more characteristics corresponding to the need of the user. The method further includes processing the need to generate one or more actionable recommendations. The need being processed based on at least one of the one or more characteristics. Further, the method includes providing the one or more actionable recommendations for enabling the user to perform one or more actions. The one or more actions corresponding to at least one of the one or more actionable recommendations.

An example of a system for providing one or more actionable recommendations relevant to a need of a user includes a need capturing module configured to capture the need of the user. The need capturing module captures the need by receiving a query from the user. The system also includes an analyzing module for analyzing the need to determine one or more characteristics corresponding to the need of the user. The system further includes a processing module to process the need to generate one or more actionable recommendations. The need being processed based on at least one of the one or more characteristics. Further, the system includes an output module configured to provide the one or more actionable recommendations to the user. The one or more actionable recommendations enable the user to perform one or more actions. The one or more actions corresponding to at least one of the one or more actionable recommendations. Moreover the system includes a feedback module for enabling the user to provide feedback for the one or more actionable recommendations based on the need of the user.

An example of a computer program product comprising a non-transitory computer usable medium having a computer readable program code embodied therein for providing one or more actionable recommendations relevant to a need of a user. The computer program code, when executed, performs a method that includes capturing the need of the user. The need being captured by receiving a query from the user. The method also includes analyzing the need to determine one or more characteristics corresponding to the need of the user. The method further includes processing the need to generate one or more actionable recommendations. The need being processed based on at least one of the one or more characteristics. Further, the method includes providing the one or more actionable recommendations for enabling the user to perform one or more actions. The one or more actions corresponding to at least one of the one or more actionable recommendations. Moreover the method includes enabling the user to provide feedback for the one or more actionable recommendations based on the need of the user.

Here, the one or more actionable recommendations may have limited number of recommendations such as ‘1’ to ‘9’. Further, the actionable recommendations may be relevant and personalized to the need of the user. Further, the user may be enabled to crystallize the need and to provide feedback to iterate the need processing for refined and relevant recommendations.

### BRIEF DESCRIPTION OF FIGURES

In the following drawings like reference numbers are used to refer to like elements. Although the following figures depict various examples of the invention, the invention is not limited to the examples depicted in the figures.

FIG. 1 is a block diagram of an environment in accordance with which various embodiments can be implemented;

FIG. 2 illustrates a block diagram of a system for providing one or more recommendations to a user in accordance with one embodiment of the present invention;

FIG. 3 illustrates a block diagram of a system for providing one or more recommendations to a user in accordance with another embodiment of the present invention;

FIG. 4 is a flowchart illustrating a method for providing one or more actionable recommendations relevant to a need of a user, in accordance with one embodiment of the present invention;

FIG. 5 is a flowchart illustrating a method for processing a need, in accordance with one embodiment of the present invention;

FIG. 6 is an exemplary illustration of a need processing to generate one or more recommendations, in accordance with one embodiment of the present invention;

FIG. 7 is an exemplary illustration for set of recommendations and corresponding actions associated with the need, in accordance with one embodiment of the present invention;

FIG. 8 is a flowchart illustrating ranking of one or more recommendations obtained from humanized web, in accordance with one embodiment of the present invention; and

FIG. 9 is an exemplary illustration of relevant actions associated with actionable recommendations corresponding to a need, in accordance with one embodiment of the present invention.

### DETAILED DESCRIPTION

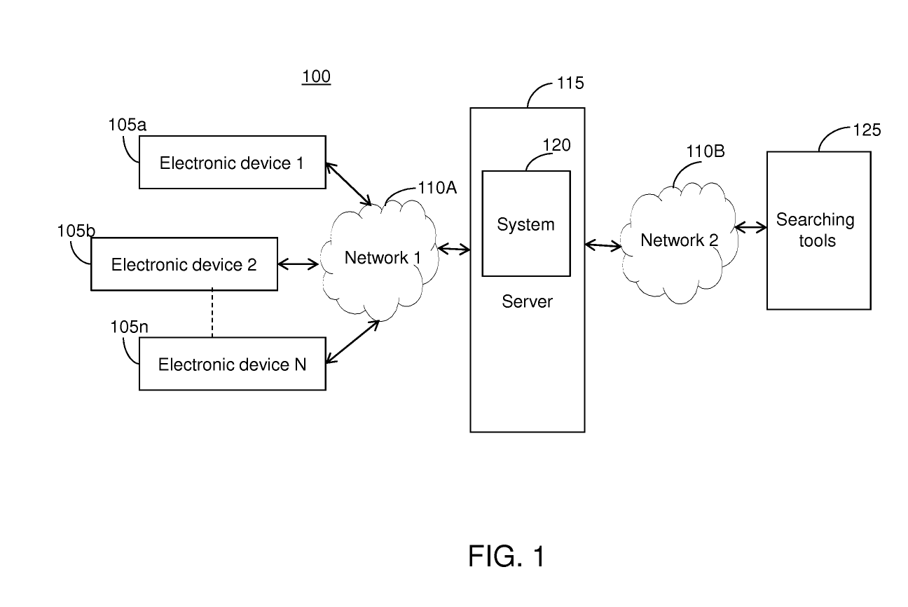

FIG. 1 is a block diagram of an environment 100 in accordance with various embodiments of the present invention. The environment 100 includes one or more electronic devices such as an electronic device 1 105a, an electronic device 2 105b, . . . to an electronic device n 105n, a network 110A and a network 110B, a server 115, a system 120, and searching tools and services 125.

A user can express a need using an electronic device such as the electronic device 105a. Examples of the electronic devices include, but are not limited to, desktop, laptop, hand held computers, mobile phone, personal digital assistant (PDA), smart phones, digital television (DTV), internet protocol television (IPTV), and play stations. The need may be represented by providing a query for which corresponding information is required by the user. The need (query) may be expressed in various forms. Examples of various forms include, but not limited to, a textual form, an image, an audio and the like. Further, the need can be categorized into various types. Examples of types of the need include, but are not limited to, a personal need, an informational need and a social need. In an embodiment, the need may be categorized based on domain of the query. For example, if the query is related to watching a movie, the need main be categorized as entertainment need.

The need expressed by the user may be provided to the system 120 through the network 110A. The system 120 may process the need by determining one or more characteristics of the need. The characteristics of the need may include, but are not limited to, entity names present in the need, type of the need, intent of the user corresponding to the need, one or more tags, concept, and location information corresponding to the need of the user. Upon processing, the system 120 may provide one or more recommendations. The one or more recommendations may be a small set of recommendations based on the need of the user. In an example, the one or more recommendations include a set having limited number of recommendations such as ‘1’ to'9′.

In one embodiment, the one or more recommendations may be provided with one or more options to enable the user to perform the one or more actions corresponding to at least one of the one or more actionable recommendations. The user may utilize the options to perform the one or more actions to fulfill the need.

The system 120 can be uploaded to the server 115. Furthermore the system 120 can also be installed as an application on, for example, but not limited to, social networking sites, private sites and public sites. Moreover, the system 120 can also be a standalone module that can be used to provide the one or more actionable recommendations responsive to the need. The need can be expressed by the user using a User Interface (UI) generated by system 120. In one embodiment, the system 120 may provide a Graphical User Interface (GUI) to enable the user to provide a search query (corresponding to the need) to the system 120. In another embodiment, the system may be implemented through other applications. In such cases, the applications may provide the Graphical User Interface (GUI) to enable the user to provide a search query (corresponding to the need) to the system 120. Further, the recommendations along with corresponding actions may be provided to the user through the GUI. Additionally, the system 120 may provide various features to the user to modify the need.

In one example, the user can express the personal need. The personal need may be provided to the system 120 through the network 1 110A. Examples of network 1 110A may include, but are not limited to, internet, Ethernet, local area network (LAN), wireless, wide area network (WAN), metropolitan area network (MAN), and small area network. The system 120 may process the personal need of the user to generate one or more recommendations associated with the personal need. Further, the system 120 may transmit the one or more recommendations associated with the personal need to the user (through the electronic device that is being utilized by the user) through the network 1 110A. For example, the user may wish to set a reminder or to create a to-do task, and the like. In one example, the one or more recommendations may be considered as a message (that may be provided by the system 120) responsive to the personal need.

Further, in another example, the user can also express the informational need. The need expressed by the user can be transmitted to the system 120 through the network 1 110A. The system 120 may process the need to search, information specific to a particular field, responsive to the need.

The system 120 may receive the informational need expressed by the user through the network 1 110A. The system 120 may communicate with the searching tools 125 through the network 2 110B to obtain the one or more recommendations associated with the need. Examples of the searching tools include, but are not limited to, various search engines such as ‘Google’ and ‘Yahoo’ and various web sites such as'ask.com', ‘Shopzilla.com’, ‘altavista.com’, ‘about.com’, ‘answers.yahoo.com’, ‘Wikipedia.org’, ‘yelp.com’, Sabre, ITA Software, Last.fm, Amazon, etc. The system 120 may identify various searching tools, such as the searching tools 125, to perform a search corresponding to the need to obtain the actionable recommendations. The system 120 may obtain a limited number of recommendations, generated as a result of searching, through the network 2 110B. Further, the one or more recommendations (hereinafter referred to as “recommendations”) obtained by the system 120 are provided to the user of the electronic devices through the network 110A.

Furthermore, the searching tools 125 may include various websites such as, but are not limited to, social networking web sites, for example, Orkut, Facebook and twitter, public networking web sites, domain specific sites and private web sites. Various websites may be employed to obtain the one or more recommendations associated with the need. Various social networking web sites and public networking web sites allow one or more other users to express their opinions on a particular recommendation associated with the need. The searching tools 125 may also have access to various databases. Various databases may store the recommendations associated with the need for future references. Further, various databases may be utilized by the searching tools 125 to obtain the recommendations associated with the need. Further, the recommendations obtained by the searching tools 125 are provided to the user by the system 120.

Moreover, the system 120 can have access to various domain specific sites. Examples of domain specific sites include, but are not limited to, movies.com and travels.com. The system 120 may identify domain(s) corresponding to the need. Accordingly, the system 120 may utilize at least one of the domain specific sites to obtain recommendations associated with the identified domain.

Further, it may be appreciated by any person skilled in the art that the need may be categorized in more than one types or domains and accordingly, the search for the recommendations may be performed for all the relevant categories of the need so as to provide relevant, but limited number of, recommendations to the user.

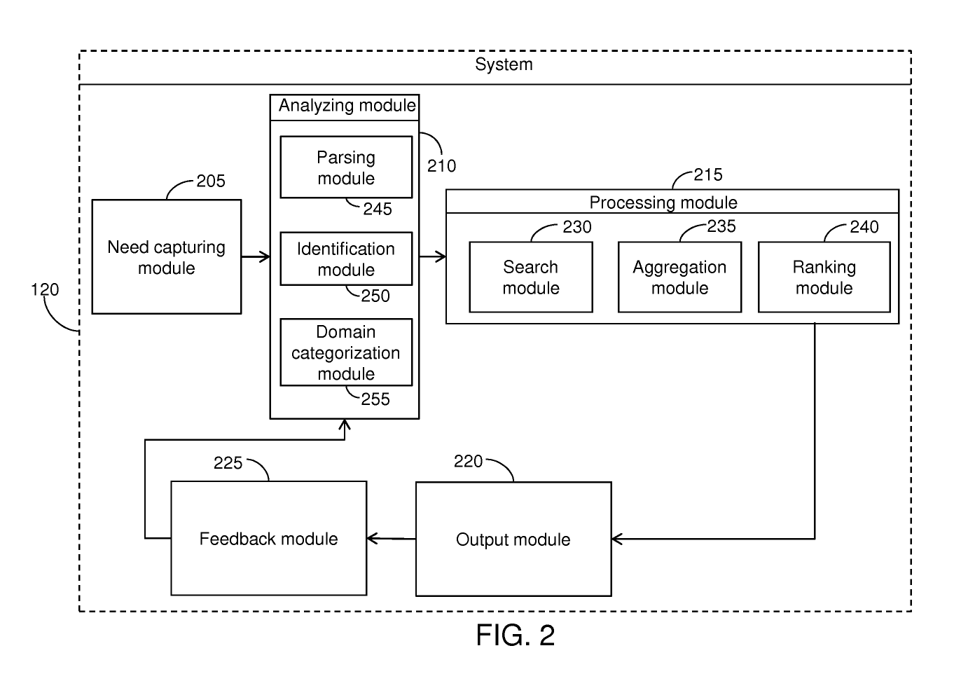

FIG. 2 illustrates a block diagram of a system, such as the system 120, for providing one or more actionable recommendations relevant to a user, in accordance with one embodiment of the present invention. In an embodiment, the system 120 is an online system that is accessible by a user through a network, such as Internet (as explained earlier in conjunction with FIG. 1).The system 120 includes a need capturing module 205, an analyzing module 210, a processing module 215, an output module 220 and a feedback module 225. Further, the processing module 215 includes a search module 230, an aggregation module 235 and a ranking module 240.

The user may provide a query to the system 120. The query can be regarded as a need of the user. The query may be represented in various forms such as textual format, a video format, an audio format, an image and the like. In an embodiment, if the query (need) is entered as a voice then the voice gets converted into a text string using a voice to text conversion technique. The query provided by the user may be received by the need capturing module 205 to capture the need. The need capturing module 205 may capture, in one example, identify keywords present in the query for capturing the need.

Further, the need capturing module 205 may capture the need from Rich Context. The Rich Context may include contextual information available relevant to the need. Further, the Rich Context may include information corresponding to, but is not limited to, ‘Static and Dynamic profile’ of the user, event or situation context corresponding to the user, ‘previous needs and transactions’, past behavior and information from public and social networks. The static and dynamic profile information may include, the user's personal and family profile, user's preferences (either explicitly given by the user or learnt from previous interaction of the user with the system 120), current location of the user, recent activities of the user, past behavior of the user and the like. For example, the user's profile may include static information or dynamic information that may be employed by the need capturing module 205 for capturing the need. Furthermore, the need capturing 205 module may determine a past behavior of the user for capturing the need. The past behavior of the user can be determined by maintaining a history of one or more queries and their corresponding one or more recommendations. The need captured by the need capturing module 205 may be transmitted to the analyzing module 210 for analyzing the need.

The analyzing module 210 may analyze the need (captured by the need capturing module 205) to determine the various characteristics corresponding to the need of the user. In one embodiment, the analyzing module 210 may analyze the need to determine an intention corresponding to the need.

The analyzing module 210 includes a parsing module 245, an identification module 250 and a domain categorization module 255. The parsing module 245 may parse the need to determine entity data corresponding to the need. The entity data may include data corresponding to one or more entities of the need. The parsing module 245 may utilize a natural language parsers (such as CMU link parser or Stanford NLP) to parse the text of the need (query). Further, the parsing module 245 may identify different parts of speech, e.g. nouns, verbs, adjectives. Also, the parsing module 245 may use other tools to identify entity names, such as names of people, movies, books, etc., from the need. Further, variety of online and offline entity databases, such as Wikipedia, imdb, etc, may be utilized to identify the details of these named entities. In another embodiment, entities present in the query can be regarded as for example, but not limited to, renowned personalities, famous locations, popular movies and the like.

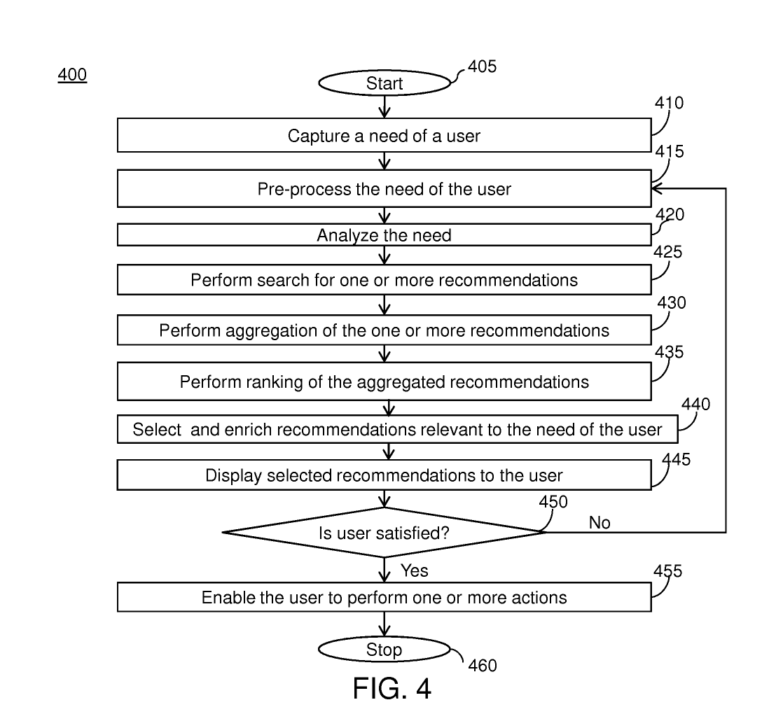

In one example, the parsing module 245 may employ a Right Most Matching String (RMMS) algorithm to determine the one or more entities present in the query. The Right Most Matching String algorithm (hereinafter referred to as “RMMS algorithm”) has been explained further in conjunction with FIG. 4). The entities, present in the query, may be determined for obtaining one or more recommendations associated with the determined one or more entities by the processing module 215.

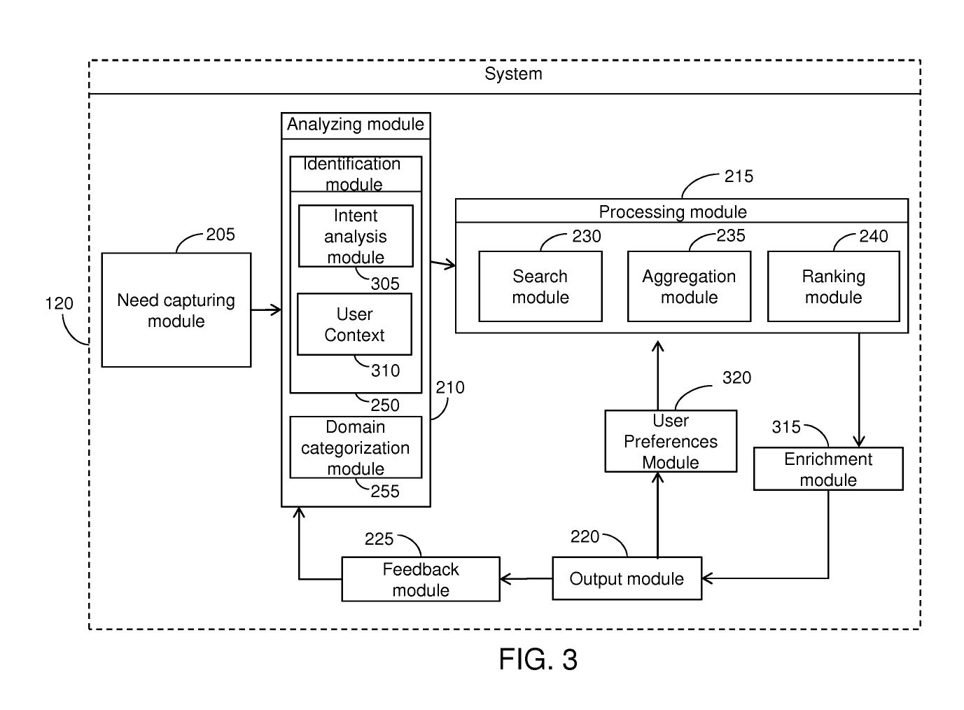

Further, the analyzing module 210 may include an identification module 250 to identify a type of the need and other information corresponding to the need of the user. The need can be classified into various types. Examples of various types include, but are not limited to, a personal need, an informational need and a social need. The types of need are described further in conjunction with FIG. 3. The other information corresponding to the need includes, but is not limited to, day, the user's intent, date and time related information, location, concepts and tags associated with text of the need.

The user's intent corresponding to the need may be determined based on the various parts of speech tagging details such as nouns, subjects, verbs, adjectives, adverb, conjunction, interjection and the like. Such various parts of the speech may be identified through the parser.

In one embodiment, a Natural Language Processing (NLP) algorithm may be utilized to identify the user's intent for the need. The NLP algorithm may identify natural human language and convert it into a format that can be interpreted for computer program manipulation purposes.

Further, intent analysis also includes identifying date and time related keywords. In one example, intent analysis may identify keywords such as “urgently”, “immediately”, “right now” and the like. Date and time related keywords may be utilized for providing recommendations corresponding to date and time related keywords. Furthermore intent analysis also includes identifying tags. Tags may be keywords describing, in one example, an impression of a recommendation. Intent analysis includes identification of such tags associated with the need. Identification of tags associated with the need may be utilized for further processing of the need.

In one embodiment the analyzing module 210 may identify the intent based on domain categorization. The intents identified based on domain categorization may be regarded as domain specific intents. Examples of domain specific intents include, but not limited to, downloading information from the web, determining show timings for a particular movie and the like. In one example, if the need is related to the movie domain, the key phrases from the query (need) may be matched against different keywords to identify the intended action, such as finding a good, current movie, or finding show times for a given movie and the like.

Further, the analyzing module 210 may include a domain categorization module 255 to determine one or more domains corresponding to the need. The domain categorization module 255 may identify the probable domains corresponding to the need. For example, the need may relate to, but is not limited to, travel, movies, shopping, etc. In an embodiment, the domain categorization module 255 may utilize various algorithms to analyze the need depending on the domain. Further, domain Ontologies may be utilized to identify the user intent (e.g. intended action, subject, special conditions, etc.). etc. An example of ontology for a movie domain can include various nouns and verbs related to the movie domains along with their relationship and list of the instances. The system may capture a database of domain specific entities. For example, in the movie domain, a list of movies, list of actors, a list of directors, a list of producers, etc. can be populated from commercial databases like IMDB or free databases like Freebase or dbpedia. The entities expressed in the need may be matched with such entity databases and if a match found then the need may potentially be related to the domain. For some domains, the solution may contact external services or content databases to identify the entities. Further, a weightage for each domain may be identified by utilizing Category-specific White Lists. For example, if a high proportion of results are from sites or domains listed in the Facts and Figures white list, and then the Facts and Figures category is given a higher weightage.

In another embodiment, domain categorization may be done using search results and matching identified entities with domain specific ontology of entities. According to this approach, one or more search engines may be searched for the key phrases identified by the entity extraction algorithm or the original text string is submitted. The search engines returns a set of results along with their URLs and matched phrases and their counts. The phrases with maximum score that is maximum matches can be identified as entities. The URLs can be searched against a set of vast bug popular URLs that are maintained by the solution along with their domains identified programmatically based on the Meta-Information specified by the site provided or manually entered by the system operator. The search results URLs are matched with the list of URLs and count for matched domain is derived. Similarly, the entity extraction module may identify verbs. The system may maintain a map of verbs and their possible domains and intentions. Based on the verb matching, the domain categorization may further be refined. Both the URL mapping as well as verb mapping is further augmented by other entities extracted from the need statement. The other entities are matched for entity database for places, products, movies, people etc. Their matching to different domains gives the domain counts for the need. The domain and intent derived from these various matching gives possible domains and their weightage.

The domain categorization techniques may infer that a need belongs to one or more domains along with their corresponding weightages. The weightages are used to determine a set of domains from a plurality of domains stored in the domain database. The set of domains are determined by finding the distances in the weightages for each of the set of domains. Further, the domains weightages may be stored. The stored weightages may be used for obtaining one or more actionable recommendations in future. Upon failure to identify a domain associated with the need, the domain categorization module 255 may consider a Web domain as a default domain. Further, in this case, a search engine based web search may be carried out for the domain.

The characteristics determined by analyzing the need may be provided to the processing module 215. The processing module 215 may process the need to generate one or more actionable recommendations relevant to the need and to the user. The one or more recommendations may include small set of recommendations containing limited number of recommendations. For example, the number of recommendations, in the set of recommendations, may vary from ‘1’ to ‘9’. The need may be processed to obtain the recommendations based on at least one of the one or more characteristics. The processing module 215 includes the search module 230, the aggregation module 235 and the ranking module 240 for processing the need.

The processing module 215 performs various stages to obtain the one or more actionable recommendations responsive to the need. Examples of various stages include, but not limited to, a searching stage, an aggregating stage, a ranking stage and filtering stage. The search module 230, the aggregation module 235 and the ranking module 240, embedded in the processing module 215, can be employed for performing various stages for obtaining the one or more actionable recommendations responsive to the need.

The search module 230 may search various information providers to obtain one or more sets of recommendations therefrom. Each set of the one or more sets of recommendations is obtained from at least one of the one or more information providers. This may be understood in conjunction with the description as follows.

Further, the search module 230 may be employed for performing search for recommendations responsive to the need. The search module 230 may perform search using one or more keywords or entities extracted from the processed need. Further, the search module 230 may perform search based on one or more domains and intention identified, as discussed earlier in this document. The solution may maintain a map of domains, intents and the sources of information need to be contacted to. The search module 230 may have access to various information providers like searching tools, such as the searching tools 125. The searching tools may include various web sites, like (but are not limited to) online directory services, online catalog services, online stores, online travel or entertainment sites, and web search engines. Examples of search engines include, but not limited to, Google, Bing, Yahoo, Ask.com TripleMe.com, Shopzilla.com, altavista.com and the like. Search engines may perform search for one or more recommendations included in a plurality of web pages present in the World Wide Web. Such searching tools are already explained in conjunction with FIG. 1 and further in this document, thus are not repeated here for the sake of brevity.

The web sites may include, but are not limited to, various domains specific web sites, social web sites, public networking web sites and the like. Examples of domain specific sites include, but not limited to, movies.com, Amazon.com, and travels.com as well as Broker Sites. The search module 230 may employ domain specific sites to search information requested in the need for a domain. For example, when a user need like “showtimes of Black Swan” is processed by the Need Analyzing module 210, it may extract ‘movie’ as a domain, ‘showtime’ as an intention, and “Black Swan” as the name of the movie. When this processed need is given to the Search Module 230, it identifies movie related service, specifically those who lists theaters and show times, provider to contact and passes the name of the movie. The Search Module 230 may maintain a map of domain categorization, intent and search provider. This map may be used to identify one or more appropriate target service provider to be contacted for a need. Furthermore, the search module 230 may have access to one or more databases. The one or more databases may store one or more recommendations corresponding to multiple needs. Such stored recommendations may be utilized for future references corresponding to the need for a similar user (having similar preferences). The search module 230 may employ the one or more databases to obtain the one or more recommendations associated with the need.

Moreover, the search module 230 may access various specialized sites. Examples of specialized sites include, but are not limited to, yelp.com, answers.com, local.yahoo.com, Amazon.com, Trueknowledge.com, Wikipedia.org, Dbpedia and the like. The search module 230 may employ specialized sites for searching recommendations associated with the need. Further, the search module 230 transmits the one or more recommendations obtained from various sources such as search engines, plurality of databases, various domain specific sites, specialized sites and the like to the aggregation module 235 for further processing.

The one or more sets of the recommendations may be obtained from one or more service providers. For example, if the need corresponds to a ‘Jennifer Lopez’ then the various domains associated with ‘Jennifer Lopez’ can be considered. The various domains can include a movie domain as she being an actress, as well as a music domain as she also being a singer. Thus, in this case, two sets of recommendations may be obtained from different websites say one related to movie and other website is related to music or concerts.

Further, the aggregation module 235 may consolidate at least one recommendation from each set of recommendations obtained from various sources (as explained in conjunction with description of ‘search module 230’) to obtain a list of aggregated recommendations (hereinafter referred to as ‘aggregated list’). For example, in continuation with the previous example, the aggregation module 235 may select three recommendations from the first set corresponding to movie domain for ‘Jennifer Lopez’ (need) and two recommendations from the second set corresponding to music domain for ‘Jennifer Lopez’ to form an aggregated list. The selection percentage may depend on the percentage of the domain weightages.

In one embodiment, the aggregation module 235 may obtain the aggregated list of recommendations based on relevancy of the recommendations corresponding to the need. In one example, the aggregation module 235 may employ Levenshteins Distance algorithm to obtain the relevancy of the need and to remove duplicates or very close results and to introduce diversity. Additionally, each domain may have domain specific diversity algorithm that would be used to maintain diversity in the results. In another embodiment, the aggregation module 235 may obtain the aggregated list of recommendations based on user preferences.

Further, the aggregation module 235 may also filter noise that may be present in the one or more recommendations obtained as a result of searching by the search module 230. The aggregation module 235 performs noise filtering based on search engines and various web sites providing the recommendations, based on domain specific sites providing the recommendations and the like. The aggregation module 235 transmits the aggregated list of recommendations to the ranking module 240. In another embodiment, the aggregation module 235 may employ a Ring of Recommendation algorithm to obtain the aggregated list of recommendations. The Ring of Recommendation algorithm may generate the aggregated list based on one or more keywords present in the need, profile information of the user and the like. Further, the Ring of Recommendation algorithm may rate the one or more recommendations based on relevancy of the need.

The ranking module 240 may provide ranks to each recommendation present in the aggregated list of recommendations (provided by the aggregation module 235). The ranking module 240 performs ranking to obtain a ranked list of one or more recommendations responsive to the need. The ranking module 240 may perform ranking based on closeness of the recommendations to the need of the user. Further, the ranking module 240 may perform ranking based on relevance of the need. Furthermore, the ranking module 240 may employ various ranking algorithm for providing ranks. Selection of ranking algorithm may be based on the associated domain of the recommendation. The algorithm may be function for providing ranks to the plurality of recommendations present in the aggregated list of recommendations. In one example, the ranking module 240 may employ a boosting tree algorithm for providing ranks to the plurality of recommendations present in the aggregated list of recommendations. Further, the ranking module 240 may select the one or more recommendations from the aggregated list based on the ranks. In an embodiment, higher ranked recommendations may be selected, from the aggregated list, to form a relevant and limited list of the recommendation. The selected one or more recommendations obtained by the ranking module 240 may be transmitted to the output module 220.

The output module 220 may provide the one or more recommendations, selected by the ranking module, to the user. Further, the output may be provided in the form of an application through an Application Program Interface (API). Furthermore, GUI may be utilized to provide one or more recommendations to the user. In one embodiment, the output module 220 may display the one or more recommendations including one or more actions corresponding thereto. The recommendations along with corresponding probable actions may be referred to as ‘actionable recommendations’. The output module 220 may provide one or more options to the user to enable the user to perform one or more actions corresponding to the one or more recommendations. The one or more actions may specify tasks that can be performed corresponding to a recommendation, in response to the need.

Further, the one or more actionable recommendations may include value added information corresponding to the one or more actionable recommendations, associated with the need. The value added information may include, but is not limited to, available coupons, links to rich information corresponding to recommendations, information corresponding to the need such as related concepts, categories and related entities. The rich information may include, but is not limited to, a summary and most important information (like prize of the product or service etc) as well as actions, related to the recommendations, may be presented. For example, for a recommendation corresponding to a good restaurant, the rich information may be providing by providing relevant information, such as menu, type, picture, address, map, phone, coupon, booking ability, reviews and the like, may be provided. Such relevant information may directly be provided to the user or the user may be enabled to access such recommendations by performing hinted actions. The user may be enabled to select a recommendation that is relevant to the need, from the one or more recommendations displayed by the output module 220.

It may be appreciated by any person skilled in the art, that the output module 220 may provide various types of additional information that may guide the user to perform one or more actions corresponding to the recommendations.

The feedback module 225 may allow the user to provide a feedback for defining the need accurately. Further, the feedback module 225 may transmit the feedback to the analyzing module 210 for analyzing the feedback (defined need) as explained earlier in this disclosure. The analyzed feedback may then be provided to the processing module 215 for further processing, thereof, to get better or more similar recommendations. The feedback module 225 may receive the feedback from the user corresponding to the one or more recommendations. The feedback may be of many other forms (corresponding to the user's actions) that may be analyzed by the feedback module 225. For example, the user may provide the feedback by asking for recommendations similar to a particular recommendation. For this, the output module 220 may provide an option ‘Get Similar’ to the user. The feedback module may present various concepts in terms of keywords related to the selected one or more recommendations. The user can select appropriate concepts to provide hints to the solution for refining the recommendations. Other than solution provided concepts, the user can provide a new concept. For example, the user selecting or unselecting one of the related concepts that are provided along with the recommendations. Further, the user may also delete a concept, or add his/her own concept.

Furthermore, the feedback module 225 may accept the feedback provided by the user in the form of words describing a recommendation, For example, like, dislike, thrash, pin-in and the like. Further, the feedback module 225 may receive feedback from the user's actions corresponding to a particular recommendation. Similarly, the feedback module 225 may utilize an implicit feedback from user interaction details captured from the GUI, e.g. the user clicking on a recommendation to view the details of a recommendation, or scrolling (or not scrolling) to see all the recommendations.

FIG. 3 illustrates a block diagram of a system, such as system 120 for providing one or more recommendations to a user in accordance with another embodiment of the present invention. The system 120 includes a need capturing module 205, an analyzing module 210, a processing module 215, an output module 220, a feedback module 225, an enrichment module 315 and a user preferences module 320. Further, the processing module 215 includes a search module 230, an aggregation module 235 and a ranking module 240.

The user may provide a query to the system 120. The query may be regarded as a need of the user. The query provided by the user may be received by the need capturing module 205 to capture the need. The need capturing module 205 has already been explained in conjunction with FIG. 2 and thus not repeated here for the sake of brevity.

Upon capturing, the need is analyzed by the analyzing module 210. The analyzing module 210 may include the identification module 250 to identify a type of the need and other information corresponding to the need of the user. Further, the analyzing module 210 may include the domain categorization module 255. The identification module 250 and the domain categorization module 255 have already been explained in conjunction with FIG. 2 and thus not repeated here for the sake of brevity.

The identification module 250 further includes an intent analysis module 305 and user context module 310. The intent analysis module 305 is employed to identify an intent associated with the need. The intent analysis module 305 may utilize various algorithms to identify the intent associated with the need. In one example intent analysis algorithm may be used to identify the intent associated with the need.

Further, the intent analysis module 305 may identify a type of the need and other information corresponding to the need of the user. The need can be classified into various types. Examples of various types include, but are not limited to, a personal need, an informational need and a social need. The types of need are described further in conjunction with FIG. 4. Further, the intent analysis module 305 may utilize information corresponding to the need such as, but not limited to, date information, time related information, location information, concepts and tags associated with text of the need for identifying the intent associated with the need. Further, the intent analysis module 305 may identify keywords such as “right now”, “urgently” included in the need. Furthermore the intent analysis module 305 may identify tags and concepts associated with the text of the need provided by other users. Moreover, the intent analysis module 305 may utilize tags and concepts associated with text of the need for filtering more relevant recommendations performed in further processing of the need. The user's intent corresponding to the need may be determined based on the various parts of speech tagging details such as nouns, subjects, verbs, adjectives, adverb, conjunction, interjection, spelling correction and the like. Such various parts of the speech may be identified through, in one example, a parsing module as explained in conjunction with FIG. 2.

Further, the user context 310 utilizes user information such as user profile information including family members, current location information, date information, current situation of the user and the like. Furthermore, the user context includes information based on user preferences, user history, and the like. The user context information may be utilized to personalize the need and thereby used in obtaining relevant actionable recommendations responsive to the need. Moreover, the user context information may be utilized for identifying a domain associated with the need. A domain categorization module may be utilized for identifying the domain associated with the need. The domain categorization module 255 has already been explained in conjunction with FIG. 2 and thus not repeated here for the sake of brevity.

Upon identifying the domain associated with the need, the need is processed by the processing module 215. The processing module 215 is employed to perform various stages to obtain one or more actionable recommendations responsive to the need. Examples of various stages include, but not limited to, a searching stage, an aggregating stage, a ranking stage and filtering the search module 230 may be employed to perform the searching stage, the aggregation module 235 may be employed to perform the aggregating stage and the ranking module 240 may be employed to perform the ranking stage and filtering stage. The search module 230, the aggregation module 235 and the ranking module 240 embedded in the processing module 215, already been explained in conjunction with FIG. 2 and thus not repeated here for the sake of brevity.

Upon processing the need, the one or more actionable recommendations may be enriched. The enrichment module 315 enriches the one or more actionable recommendations by associating the one or more actionable recommendations with rich information. The rich information associated with the one or more actionable recommendations may include value added information for example, coupons, discounts, offers and the like. The user may use the value added information upon selecting one of the recommendations from the one or more actionable recommendations. Further, the enrichment module 315 may identify one or more actions associated with the one or more actionable recommendations. The enrichment module 315 may utilize, in one example, an action map for identifying actions. The enrichment module 315 may map the set of actions associated with the one or more actionable recommendations present in the action map. Further, the one or more actionable recommendations associated with enrichment information may be displayed by the output module 220.

The output module 220 may be utilized for displaying the one or more actionable recommendations and associated enrichment information. The output module enables the user to select one of the recommendations and associated actions from the one or more actionable recommendations. The user may perform actions included in the selected actionable recommendations responsive to the need.

Further, the feedback module 225 may be utilized for providing feedback by the user. The feedback may be provided to define the need accurately. Further, the feedback module 225 may be utilized to modify the need of the user. The feedback module 225 may accept feedback information in various feedback forms. The various feedback forms and the feedback module 225 have already been explained in conjunction with FIG. 2 and thus not repeated here for the sake of brevity. The feedback module 225 may transmit the feedback to the analyzing module 210 to analyze the feedback and further to identify the information corresponding to the feedback. The analyzed feedback may further be provided to the processing module 215 for processing further. The need processed based on the feedback information may be utilized for performing more relevant actionable recommendations.

Further, the User Preference Module 320, as explained earlier, captures the users history based on the users interaction with the recommendations such as performing actions as LikeIt, ShoutOut, ThrashIt, Share, Buy or book a ticket etc. These actions on recommendations may indicate the user's preference about the recommendation. Such user interaction may be captured by output module 220 or external client. However, the information may be passed on to the user preference module so as to capture the user's preferences for serving personalized recommendations to the user. For example, for every like-It or favorable Shout-out or buy or book type actions, a count on the preferences expressed as concepts related to the recommendation, is incremented for the identified Need category or domain. The preferences with maximum counts are dynamically inferred as the users preference for that type of need or recommendation. This ranking is used in the Ranking Module 240 for serving user preferred recommendations.

FIG. 4 is a flowchart illustrating a method for providing one or more actionable recommendations relevant to a need of a user, in accordance with one embodiment of the present invention. The order and number of steps in which the method 400 is described is not intended to be construed as a limitation. The description corresponding to FIG. 4 may be understood more clearly when read in conjunction with FIG. 1.

The method starts at step 405. At step 410, a need of a user is captured. Capturing may be performed by receiving a query from the user. Further, the need may be captured by obtaining information present in the user's profile. In one example, the users profile may include information regarding, but not limited to, location, time, users current event, favorites and the like. The query may be provided in various forms. Examples of various forms include, but are not limited to, textual format, keywords, phrase and sentence. Further, the query may be expressed in the form of an application hosted on websites. In another embodiment the query may also be provided in the form of an image, an audio and a video format.

In one embodiment, the user may provide the query by utilizing various electronic devices, as described in conjunction with FIG. 1. Further, the query provided by the user may be categorized into various types. Examples of various types of the need include, but not limited to, a personal need, an informational need and a social need. In one example, personal need may include, setting a reminder for a particular event. The informational need may specify, in one example, providing information corresponding to a particular query, provided by the user. The social need may specify, in one example, obtaining information, opinions corresponding to the recommendations from peers, experts included in a social circle of the user. The social need may be expressed using various social networking sites. Examples of various social networking sites include, but not limited to, Face-book, Twitter, Orkut, LinkedIn, Myspace, Mybantu and the like.

At step 415, the need is pre-processed. Pre-processing may be performed to identify a type of the need. In one example, if step 415 identifies the need as the personal and trivial need then the user is provided with recommendations responsive to the personal need. In one example, recommendations can include a message in response to the personal need. In an example, if the need of the user is to wish ‘hello’ or ‘good morning’ then an instant response may be provided to the user without waiting for any further processing of the user's need.

In another example, if step 415 identifies the need as the informational or social need, then the pre-processing stage transmits the informational need for further processing, as discussed in methods hereafter.

At step 420 the need may be analyzed to determine one or more characteristics corresponding to the need of the user. The one or more characteristics may include, but are not limited to, at least one of entity data, a type of the need, intent of the user, one or more tags, concept, and location information corresponding to the need of the user. The need may be analyzed based on heuristics. Further, the need may be analyzed by parsing the need to determine entity data corresponding to the need. The entity data may include, but is not limited to, data corresponding to one or more entities of the need.

Parsing may be performed by utilizing various algorithms. In one example the NLP algorithm can be utilized to perform parsing. The NLP algorithm may identify natural human language and convert it into a format that can be interpreted for computer program manipulation purposes. The NLP algorithm may identify various parts of speech present in the query, for example, verb, noun, pronoun, adjective, adverb, preposition, conjunction and interjection. Further, in one example, Wordnet may be utilized for parsing.

Further, the need may be analyzed to determine a domain associated with the need. A Right Most Matched String (RMMS) algorithm may be used to identify entities expressed in the need. The RMMS algorithm may be useful to determine the domain by identifying an entity associated with the need. The entity may be regarded as a renowned artist, a famous movie, a popular location and the like. The RMMS algorithm may identify the entity associated with the need by comparing the entity with various sources including information regarding the entity associated with need. Examples of various sources include, but not limited to, Dbpedia, Wikipedia, domain specific sites and the like. Furthermore, if the entity fails to be recognized in the analyzing stage, then the need can be replaced by, in one example, a temporary variable. The temporary variable may be transmitted to a Stanford POS tagger to identify various parts of speech.

Further, the need is analyzed by identifying other information corresponding to the need. The other information may include, but is not limited to, the user's intent, date and time related information, tags and concept associated with the need, and geo-location of the user. Various tag search services such as Delicious, and Concept search services such as Zemanta may be utilized to identify tags and concepts. The one or more tags may be regarded as words or sentences describing the one or more recommendations provided to the user as a result of processing. Furthermore, tags associated with the need may be used for filtering recommendations from the one or more recommendations obtained responsive to the need. Moreover, the tags also allow the user to provide one or more hints. The one or more hints may be employed to determine recommendations having increased relevancy to the need. Upon analyzing the need, the one or more recommendations are searched, as explained in step 425. Further, the need may be categorized in one or more domains (as explained earlier in conjunction with FIG. 2)

At step 425, searching for the one or more recommendations associated with the need is performed. Various information providers relevant to the identified one or more domains may be searched to obtain one or more sets of actionable recommendations therefrom. Each set of the one or more sets of actionable recommendations is obtained from at least one of the one or more information providers. The one or more recommendations may be searched by programmatically utilizing various searching tools such as search engines and web sites. Examples of search engines include, but not limited to, Google, Yahoo, Ask.com TripleMe.com, Shopzilla.com, altavista.com, and the like. Further, the searching tools may be utilized to access various databases to obtain the one or more recommendations associated with the need. In one embodiment, a sub-query defining the need can be generated. The generated sub-query may be utilized to perform search of the one or more recommendations responsive to the need. Further, during the searching stage articles included in the need may be eliminated to form the sub-query.

Further, various algorithms may be utilized to determine the availability of the one or more recommendations. In one example, meta-search algorithm may be utilized to search web pages including the one or more recommendations associated with the need.

Furthermore, the recommendations may be searched from specialized sites. Examples of specialized sites include, but not limited to, yelp.com, local.yahoo.com, answers.yahoo.com, amazon.com, trueknowledge.com and the like. Moreover, the one or more recommendations may be searched from various domain specific sites. Examples of domain specific sites include, but not limited to, movies.com, music.com, newsservices.com, travel.com and the like. Further, the one or more recommendations may be searched from various social; networking sites. Examples of social; networking sites include, but not limited to, Orkut, Facebook, Twitter and the like. Friends and experts included in a social circle of the user may provide the one or more recommendations using such social; networking sites. Upon obtaining the one or more recommendations from various sources such as search engines, databases, domain specific sites, social networking sites and the like, the method 400 proceeds to step 430.

At step 430, the one or more recommendations obtained from various sources may be aggregated. Aggregation includes obtaining a consolidated list of one or more recommendations obtained from various sources to generate an aggregated list of recommendations. In an embodiment, at least one recommendation from each set of recommendations obtained from various sources may be aggregated to form the aggregated list.

The aggregated list of recommendations is obtained based top ranked results from the search providers. Duplications from the aggregate results are removed based on the closeness of the one or more recommendations included in the aggregated list with the need. Various algorithms can be utilized to measure closeness. In one example, Levenshtein's Distance algorithm may be utilized to determine closeness. Further, since more than one provider may be contacted there could be duplicates which can be identified with distance algorithms and other domain specific algorithm to remove the duplicates. For example, when user is searching for movies, unless a specific genre type of movies are asked for or preferred by the user, the aggregated result may include different types of genres. For another example, different types of restaurants can be selected.

In one embodiment, a Ring of Recommendation algorithm may be utilized for performing aggregation. The Ring of Recommendation algorithm may aggregate the recommendations, from the sets of recommendations, generated by various sources (search engines, specialized sites, domain specific sites) based on relevance. Further the Ring of Recommendation algorithm provides ratings to each recommendation generated by various sources based on relevancy to the need. Furthermore, the Ring of Recommendation algorithm provides ratings based on the users profile information. Moreover, the Ring of Recommendation algorithm generates the aggregated list of recommendations based on the ratings provided to each recommendation.

Further, at step 430, the method 400 may eliminate noise included in the one or more sets of recommendations generated by various sources. Various negative filtering techniques and noise reduction techniques can be utilized to eliminate noise. Noise elimination may be performed to increase the relevancy of the recommendations to the need. Upon generating the aggregated list, the recommendations present in the aggregated list are ranked as described in step 435.

At step 435 ranking of the recommendations present in the aggregated list is performed to obtain a ranked list of one or more recommendations. Ranking of the one or more recommendations present in the aggregated list may be performed based on relevancy to the need. Further, ranking may also be performed based on information available in the user's preferences and user's profile. The user's preferences, as explained earlier, may be gathered from the users past interaction with the solution. The information available in the user's profile can be referred to as a rich context that may be passed in by a calling application or may be retrieved using the user's identification or context. The usage of user preferences would provide relevant personalized recommendations to the user. For example, if a user previously asked for Italian and Indian restaurants more than other restaurants or the user booked tables or shouted favorably for those types of restaurants, then the user's preference would indicate Italian and Indian as highest preferred restaurants and the ranking algorithm would rank them more.

Various ranking algorithm may be utilized to perform ranking. In one example boosting tree algorithm for providing ranks to the one or more recommendations present in the aggregated list of recommendations. Further, a domain specific ranking may be utilized to perform ranking. The domain specific ranking may provide ranking by measuring the closeness of a plurality of domains with the domain associated with the need. Furthermore, ranking may be performed based on the ratings provided to the one or more recommendations present in the aggregated list. Moreover, ranking may be provided to the one or more recommendations obtained from friends or experts through social networking sites.

Rankings obtained from various source such as domain specific ranking, ranking provided based on ratings, rankings provided to the one or more recommendations obtained from friends or experts through social networking sites are consolidated. The consolidated rankings are normalized to generate the ranked list of recommendations responsive to the need.

Further, at step 440, one or more recommendations relevant to the need of the user, may be selected. Further, each of the recommendations may be enriched with one or more actions and rich information. The one or more actions associated with a recommendation may be determined by utilizing an action map as explained earlier in conjunction with description of FIG. 3. Further, at 445, the selected one or more recommendations may be provided to the user.

At step 445 the selected one or more recommendations may be displayed to the user. In one embodiment the one or more recommendations may include one or more actions that can be performed responsive to the need. In an embodiment, the ranked list, generated at 435, may be provided to the user. The user may then select the one or more recommendations from the ranked list. Further, the user may select one of the one or more actions that can be performed responsive to the need. In one example, if the one or more recommendations are associated with restaurants, then the one or more actions may include, “book a table”, “display menu”, “book a cab to reach the restaurant” and the like.

At step 450 it is determined whether the one or more recommendations satisfy the need of the user. The user may be satisfied, if the one or more recommendations include one or more actions responsive to the need. If the user is satisfied, then the method proceeds to step 455 (shown by the “Yes” branch from 450). Further, if the one or more recommendations responsive to the need is unavailable included in the ranked list, then the method proceeds to 415 (shown by the “No” branch from 450).

Furthermore, if the one or more recommendations responsive to the need are unavailable, then the user can provide feedback describing the need. In one example, the user may be provided with hints. Hints may be referred to as a word or phrase describing the need accurately.

Moreover, feedback may also be in the form of an opinion provided by the user for the one or more recommendations. In one example “like” can be provided as feedback indicating that the user is interested in the recommendation. In another example “dislike” can be provided as feedback indicating that the user is not interested in the recommendation displayed.

Further, the user may also provide feedbacks by adding tags to the one or more recommendations displayed. In one example, tags may be words or sentences describing the need accurately. Tags may also be employed by the user to alter the need completely.

Furthermore, the user can acquire recommendations similar to the one or more recommendations displayed. In one example “find similar” option can be employed by the user to obtain recommendations similar to the one or more recommendations displayed.

Moreover implicit feedback may be provided by the user. In one example, implicit feedback include, the user clicking on a particular recommendation to view details included in the particular recommendation.

At step 455, the user is enabled to perform one or more actions corresponding to the one or more actionable recommendations. The one or more actions may include one or more tasks that can be performed by the user, corresponding to the one or more recommendations, in response to the need. Further, the one or more actionable recommendations may include one or more value added information. Examples of value added information may include, but not limited to, coupons, links to rich information such as ingredients in a dish, associated entities and the like

In one example, if the need is associated with a restaurant then the one or more actionable recommendations may include “display menu” that displays the menu of the restaurant, “book a table” which may be employed for booking a table in the restaurant and the like. Further, the value added information associated with one or more actionable recommendations may include “coupons” which may provide discounts to the user. In another example, if the need is associated with a product then the one or more actionable recommendations may include “buy product” that allows the user to purchase the product, “order product” that allows the user to order the product and the like. Further, the value added information associated with the product may include, “discounts” that may specify discount available on the product and the like. The method 400 ends at step 460.

It may be appreciated by any person skilled in the art that the value added information provided to the user is not limited to the above description. Further, various other features and options may be provided to the user to enable the user to identify the suitable recommendation (from the one or more recommendations) and perform one or more actions corresponding to the identified suitable recommendation.

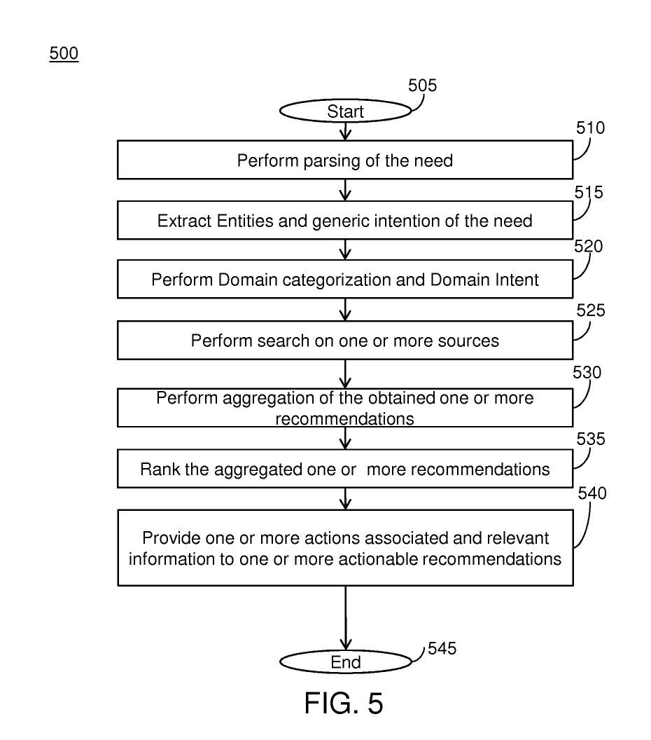

FIG. 5 is a flowchart illustrating a method 500 for processing a need, in accordance with one embodiment of the present invention. The order and number of steps in which the method 500 is described is not intended to be construed as a limitation. Various steps of method 500 are already explained in conjunction with FIG. 4, thus the detailed explanation of such steps is not repeated here for the sake of brevity. Further, the description corresponding to FIG. 5 may be understood more clearly when read in conjunction with FIG. 1 and FIG. 4.

The method starts at step 505. At step 510, parsing is performed. Parsing is performed to determine the various parts of speech, for example, verb, noun, pronoun, adjective, adverb, preposition, conjunction and interjection included in the need. Various algorithms can be utilized to perform parsing. In one example, Natural Language Processing (NLP) algorithm may be utilized to perform parsing. Parsing may be performed to determine an intention associated with the need as discussed in step 515.

At step 515 the user's intention associated with the need is extracted. The need may be analyzed to extract the intention, of the user, associated with the need. Intention associated with the need may be extracted based on parsing. Further, various algorithms may be utilized for extracting the intention associated with the need. Further, the intention associated with the need may be extracted based on heuristics. Furthermore, extracting the intention associated with the need also include categorizing the need into various types. Examples of various types include, but not limited to, a personal need, an informational need and a social need. The personal need, in one example, may be regarded as setting up a reminder to the user. In another example, the personal need may specify a to-do task to the user. The informational need may be regarded as need to obtain information corresponding to a concept. The social need may be regarded as a need to interact with people in the social circle of the user. In one example, obtaining contact information of a friend from one or more friends included in the users social circle. The social need may be expressed using communication mediums like a humanized web. Examples of the humanized web may include social networking sites such as Orkut, Facebook, Twitter and the like.

Intention of the user, associated with the need, may be extracted by identifying significant information such as date, time, and keywords, for example, “right now”, “urgently” and the like. Further, extraction of intention associated with the need includes identification of one or more tags associated with the need. The one or more tags can be regarded as words or sentences describing the one or more recommendations provided to the user as a result of processing. The one or more tags may be identified to determine the category to which the need belongs. Further, the one or more tags identified may provide the user with hints. Hints may be regarded as keywords or sentences employed to describe the need accurately by the user. Upon determining the need, a domain associated with the need is identified as discussed in step 520.

At step 520, domain categorization is performed. Domain categorization may be performed based on the intention associated with the need. Domain categorization includes determining the domains associated with the need. The need may belong to one or more domains such as, but is not limited to, movies, education, restaurants, music, product, entertainment, travel, electronics, grocery, health, toys, malls and automotives. Domain categorization may be performed by matching a keyword included in the need with a plurality of domains. The keyword included in the need may be associated with one of the domain as discussed above. The keyword associated with the domain included in the need is compared with various domains discussed above. If a match between the keyword associated with the domain included in the need and one of the various domains as discussed above is found, then the need may be categorized to the one of the domain for which match was found.

At step 525 one or more information providers may be searched to obtain one or more sets of recommendations therefrom. Each set of the one or more sets of recommendations being obtained from the one or more information providers. Various information providers may include, but are not restricted to, various search engines and web sites. Examples of search engines include, but not limited to, Google.com, Yahoo.com, Ask.com, Shopzilla.com, and altavista.com. Further, the one or more sets of recommendations may be searched from various specialized sites. Examples of specialized sites may include, but not limited to, yelp.com, local.yahoo.com, answers.com, amazon.com, trueknowledge.com and the like. Furthermore, searching may also be performed from various domain specific sites such as, but are not limited to, movie databases, music databases, travels.com and the like.

Further, searching of the one or more sets of recommendations may be performed based on user preferences, relevance, rich context, one or more characteristics associated with the need. Searching of the recommendations is explained earlier in conjunction with FIG. 2 and FIG. 4. Further, the recommendations, searched, responsive to the need may include one or more actionable recommendations. The one or more actionable recommendations may be provided with one or more options to enable the user to perform one or more tasks that may be performed responsive to the need.

At step 530, at least one recommendation from each set of recommendations (as obtained from various sources, explained earlier) is aggregated to generate an aggregated list of recommendations. The aggregated list of recommendations include consolidated list of recommendations obtained from various sources.

Further, aggregation may be performed based on relevance of the recommendations obtained from various sources to the need. Various algorithms may be utilized to determine relevance of each recommendation corresponding to the need. In one example, Levenshtein's Distance algorithm may be utilized determine relevance of the recommendations. In an embodiment, the algorithm may also be used for removing the duplicates. In one example, if the need of the user is associated with a particular product, then the one or more recommendations associated with the particular product may be provided by various sources. Further, the one or more recommendations associated with the particular product obtained from various sources may be aggregated based on relevance. Relevance may be determined by comparing description provided in each recommendation, of the one or more sets of recommendations, with the need. Furthermore, the recommendations including the closest match to the need are rated. Moreover, the recommendations rated based on closeness are aggregated to generate the aggregated list responsive to the need.

Furthermore, the recommendations obtained from social networking sites, public sites and the like may be aggregated to generate the aggregated list of recommendations. The recommendations obtained from humanized web such as social networking sites, public sites and the like may be aggregated based on various features. Examples of such various features include, but not limited to, a rating provided for a particular recommendation, validity of the need, number of days from when the particular recommendation was provided and the like.

In one embodiment, aggregation may be performed using a Ring of Recommendation algorithm. The Ring of Recommendation algorithm generates the aggregated list based on one or more keywords present in the need, profile information of the user, users preferences derived from the users past interaction with the system and the like. Further, the Ring of Recommendation algorithm may rate the recommendations based on relevancy of the need. Further, the Ring of Recommendation algorithm may determine the recommendations that are relevant to the need based on a rich context of the user. For example, the user with liking for Comedy or Romantic movies, would have those types of movies ranked higher and would be selected.

Moreover aggregation may be performed to eliminate noise included in the recommendations provided by various sources. Negative filtering techniques may be utilized to eliminate noise. Further, noise reduction techniques may be utilized to eliminate noise present in the aggregated list of recommendations. Furthermore, the aggregated list of recommendations may be ranked as described in step 535.

At step 535, the recommendations present in the aggregated list are ranked. Ranking may be performed based on relevancy of the recommendation, present in the aggregated list, corresponding to the need. Further, ranking may be provided to recommendations obtained by various domain specific sites. Furthermore, ranking may be provided to recommendations provided by humanized web such as social networking sites or public sites. Moreover, ranking provided to recommendations, obtained from search engines, domain specific sites, social networking sites, public sites and the like, are normalized to generate a ranked list of recommendations. The ranked list of recommendations may include a small set of recommendations relevant to the need. Further, the one or more recommendations may be selected, from the ranked list, based on ranks. In an embodiment, the user may be allowed to select one or more recommendations from the ranked list.

At step 540, the one or more recommendations may be provided to the user. The one or more recommendations may include a limited number of recommendations that are relevant to the need. In an example, the limited number of recommendations may be ‘1’ to ‘9’. In one embodiment, the ranked list including a small set of recommendations may be provided to the user to enable the user to select the one or more recommendations based on the need. The one or more actionable recommendations may provide one or more options for enabling the user to perform one or more actions responsive to the need. The one or more actions, corresponding to the one or more actionable recommendations, may be determined by utilizing an action map. The one or more actions may be mapped to one of a plurality of actions present in the action map. The method ends at step 545.

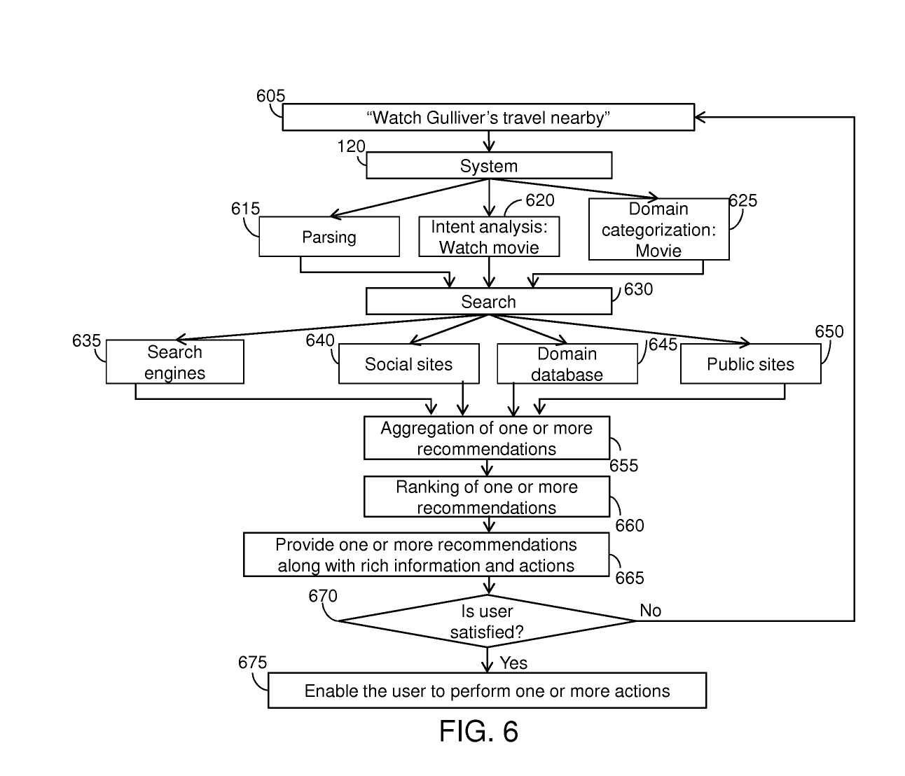

FIG. 6 is an exemplary illustration of a need analysis to generate one or more recommendations, in accordance with one embodiment of the present invention. The need “Watch Gulliver's travel nearby” as shown in 605 is provided as query by the user. A system, such as the system 120, may receive the query including the need. The system 120 may process the need by performing parsing 615, intent analysis 620 and domain categorization 625.

Parsing may be performed by using various algorithms. Parsing identifies various parts of speech such as verb “Watch”, noun “Gulliver's travel” included in the need 605. In one example NLP algorithm may be utilized to perform parsing. Further, intent analysis 620 may be performed to identify an intention associated with the need 605. The verb “watch” included in the need 605 determines the intention of the need 605. Furthermore, domain categorization 625 identifies that the need 605 is associated with a ‘movie’ domain. Upon identifying that the need 605 is associated to the ‘movie’ domain, the domain categorization 625 finds a match between keyword “Gulliver's travels” included in the need 605 with a plurality of movies stored in a movie database.

The results obtained from parsing, identifying an intention and determining the domain associated with the need may be utilized in searching one or more sets of recommendations relevant to the need. Searching may be performed using various information sources. Examples of various information sources include, but not limited to, search engines 635 such as Google, Yahoo, and the like, social sites 640 such as Orkut, Facebook, Twitter and the like, domain database 645 such as a movie database, travel database, news services and the like and public sites 650.

In order to obtain recommendations responsive to the need 605, a search is performed to identify a location included in the need. Searching performed to identify the location associated with the need may be regarded as Geo location. The keyword “nearby” may be captured to provide recommendations associated with the location preferred by the user.

Searching from various sources generates one or more sets of recommendations associated with the need. The one or more sets of recommendations may include, but not limited to, recommendations relevant to the need, personalized recommendations and actionable recommendations. Further, actionable recommendations may be analyzed to determine an action that may be performed responsive to the need. Action maps may be used to determine the action included in the actionable recommendations. In one example, the need 605 may include actionable recommendations such as ‘calling a movie theatre to book tickets’ for “Gulliver's travels”'. In another example, the need 605 may include a personalized recommendation such as booking tickets for “Gulliver's travel” nearby the user's home place. In an embodiment, the user's current location may be determined through Global Positioning System (GPS). Further, the recommendations may include reviews provided by friends or experts through social networking sites or public sites.

Upon obtaining the one or more sets of recommendations associated with the need from various sources, at least one recommendation, from each set, may be aggregated, as shown in 655 to generate an aggregated list of recommendations. The aggregated list of recommendations includes a small set of recommendations associated with the need 605. Aggregation further may include selecting recommendations based on relevance, rich context, rating and the like. Furthermore, aggregation includes filtering of irrelevant and repeated recommendations. Moreover aggregation 655 may include filtering of noise present in the one or more recommendations obtained from various sources.

Upon aggregation, the one or more recommendations associated with the need are ranked as shown in 660 to generate a ranked list of recommendations. Ranking may be performed based on, but not limited to, relevancy of the recommendation to the need, rich context of the user, user preferences and ratings provided by friends or experts and the like. Various ranking algorithm may be utilized to perform ranking. In one example, a Boosting tree algorithm may be utilized to perform ranking.

Upon ranking, the ranked list of recommendations may be provided to the user as shown in 665. Further, the ranked list of recommendations may be provided, to the user, along with the one or more actions corresponding to the recommendations and other rich information such as value added information. The rich information is explained earlier in conjunction with FIG. 4. The value added service may include, but is not limited to, discounts available on the tickets for “Gulliver's travels”, a compliment for watching the movie and the like.

If the user is satisfied, then the user can select one or more recommendations from the ranked list of recommendations as shown by “yes” branch from 670. The selected recommendation may include actionable recommendations responsive to the need. Further, the selected recommendations may include personalized recommendations responsive to the need. Further, if the user is not satisfied, then the user may provide feedback to define the need accurately as shown by “NO” branch from 670. Feedback provided by the user may be processed further to provide a new set of recommendations associated with the need.

Feedback may be in the form of selecting one or more hints by the user. The one or more hints may define the need accurately. Further, feedback may be provided in the form of indicating an option “find similar”. The option “find similar” may be used to determine recommendations similar to the recommendations included in the ranked list. Furthermore, feedback may be in the form of selecting an option “like” or “dislike”. The options “like” or “dislike” may indicate if the user is interested in a particular recommendation included in the ranked list of recommendations or if the user is not interested in a particular recommendation included in the ranked list. Moreover, feedback may be provided by the user to modify the need of the user. The feedback provided by the user may be processed further to obtain recommendations that may be, but not limited to, personalized and actionable, recommendations based on rich context and various characteristics of the need.

If the user is satisfied, the selected recommendation may be utilized to perform actions as shown in 675 corresponding to the selected actionable recommendations. In one example, actions included in the recommendations may be determined using an action map. The action map may be used to map the actions included in the recommendations to the one or more actions included in the action map. Upon determining, the user may be enabled to perform one or more actions responsive to the need. In one example, the actions may include, but are not limited to, booking tickets to watch “Gulliver's travels”, booking a cab to reach nearby location and the like.

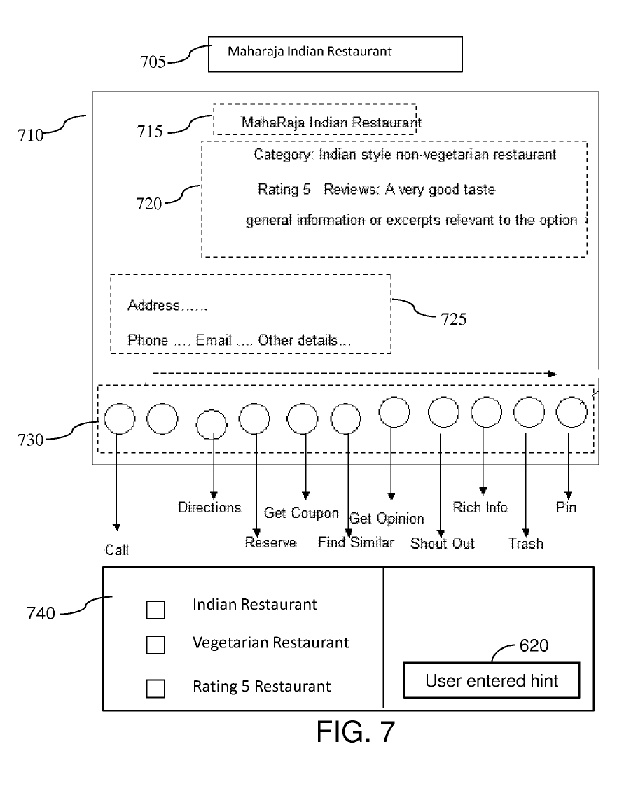

FIG. 7 is an exemplary illustration for set of recommendations and corresponding actions associated with the need. The query “Maharaja Indian Restaurant” as shown in 705 is provided by the user. The need 705 may be processed to obtain set of recommendations associated with the need 705. The need 705 is captured. Capturing is performed by receiving a query provided by the user. Further, the need 705 may be captured by obtaining information present in a rich context of the user. Upon capturing the need 705, the need is pre-processed. Pre-processing is performed to identify the type of the need.

Upon pre-processing the need may be analyzed to determine an intent corresponding to need. The need may be analyzed based on heuristics. Further, the need may be analyzed by parsing the need. Parsing may be performed by utilizing various algorithms. In one example the NLP algorithm can be utilized to perform parsing. The NLP algorithm may identify natural human language and convert it into a format that can be interpreted for computer program manipulation purposes. Further, the need may be analyzed to determine a domain associated with the need. A RMMS algorithm may be used to determine the domain. The RMMS algorithm may determine the domain by identifying an entity associated with the need. The domain for the need 705 may be identified as “restaurant” based on the keyword “restaurant” included in the need 705. The “restaurant” keywords identifies ‘dining or restaurant’ domain.

Upon identifying the intent associated with the need searching for the set of recommendations, in this example one recommendation, as shown in 710 is performed. The set of recommendations may be searched from various sources. Examples of various sources include, but not limited to, search engines such as Google, Yahoo and the like, domain specific databases such as, movie database, music database, news search and the like, social networking sites such as Orkut, Facebook, Twitter and the like, public sites, specialized sites such as yelp, answers.com, Trueknowledge.com and the like, business directories, product categories and the like. In the example, since the “restaurant” domain has been identified, the restaurant related sources are searched for the keyword “Maharaja Indian Restaurant”. For example, Open Table, Yelp, Yahoo.local etc sources may be contacted and returned results are aggregated, duplications are removed, the recommendations are ranked and processed for the close matching with the Need 705. In the example, there was just one “Maharaja Indian Restaurant” found in the city hence one recommendation 710 is presented. More information relevant to the recommendation is filled with the recommendation. For example, the recommendation may include Subject or name or title 715, more details 720 and 725 about the recommendation.

The recommendations obtained may include actions identified as 730 that enable to perform actions such as call, book table, Shout-out, thrash it, share, and the like. Further, recommendations may include an action for finding recommendations similar to presented recommendation. Furthermore, actions on the recommendation may include reviews and getting opinion for the restaurant “Maharaja”. The ratings and reviews may be provided by friends or experts through social networking sites or public sites and the like.

Further, 730 may include value added information such as “coupons” available for providing discounts, direction map to reach “Maharaja” restaurant and the like. The value added information may provide essential details associated with the restaurant “Maharaja”.

Further, the set of recommendations may include value added information, such as coupons and various offers, corresponding thereto. The actionable recommendations may include one or more actions such as calling the restaurant “Maharaja” to book a table, sending an email to determine menu provided by the restaurant “Maharaja” and other details as shown in 730.

Further, if the user is not satisfied with the set of recommendations provided, the user can provide a feedback as shown in 740. Furthermore, feedback may be in the form of selecting an option, in one example, “like”. The options “like” may indicate if the user is interested in a particular recommendation. In another example, the user can select an option “trash” indicating that the user is not interested in a particular recommendation. Moreover, feedback may be in the form of selecting a “pin-in” option. The “pin-in” option may be utilized by the user to save the recommendation for future use.

Further, if the user liked a recommendation but wanted similar more recommendations, the user can use Feedback or Need Crystallization functionality 740. The option “find similar” may be used to determine recommendations similar to the recommendations included in the ranked list. The Find Similar option, an example of Need Crystallization, provides hints or concepts related to the recommendation. Further, hints may include rating for the restaurant “Maharaja”. The feedback may define a need accurately.

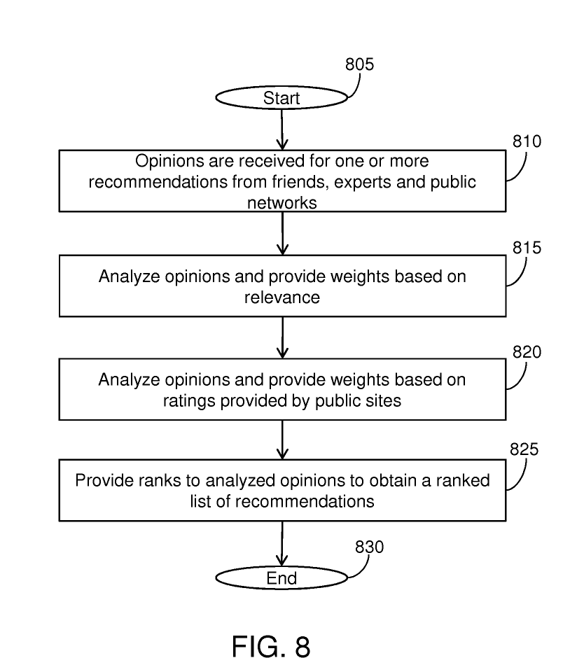

FIG. 8 is a flowchart illustrating ranking of one or more recommendations obtained from humanized web. The method starts at step 805. At step 810 opinions are received for one or more recommendations. Opinions may be provided by friends, experts and the like. Opinions may be provided utilizing public sites or social networking sites. Opinions may include, in one example, reviews, ratings and the like. In another example, opinions may include providing a set of recommendations similar to the one or more recommendations provided by a system, such as the system 120.

At step 815, opinions provided by friends, experts and the like are analyzed. Analyzing includes identifying tags. Tags may be regarded as keywords describing a notion of the recommendations. Further, analyzing may be performed based on relevancy of the recommendations to the need.

At step 820, opinions provided by friends, experts and the like are analyzed based on ratings provided. The ratings may be provided by friends, experts and the like through public sites or social networking sites. The ratings, in one example, may describe the notion, features and the like of a particular recommendation.

At step 825, rankings are provided based on opinion analysis performed in step 815 and step 820 to generate a ranked list of recommendations. The ranked list of recommendations may include a small set of recommendations relevant to the need. Ranking further includes filtering recommendations that are not relevant to the need. Ranking algorithms may be used to perform ranking as explained in conjunction with FIG. 4. The method ends at step 830.

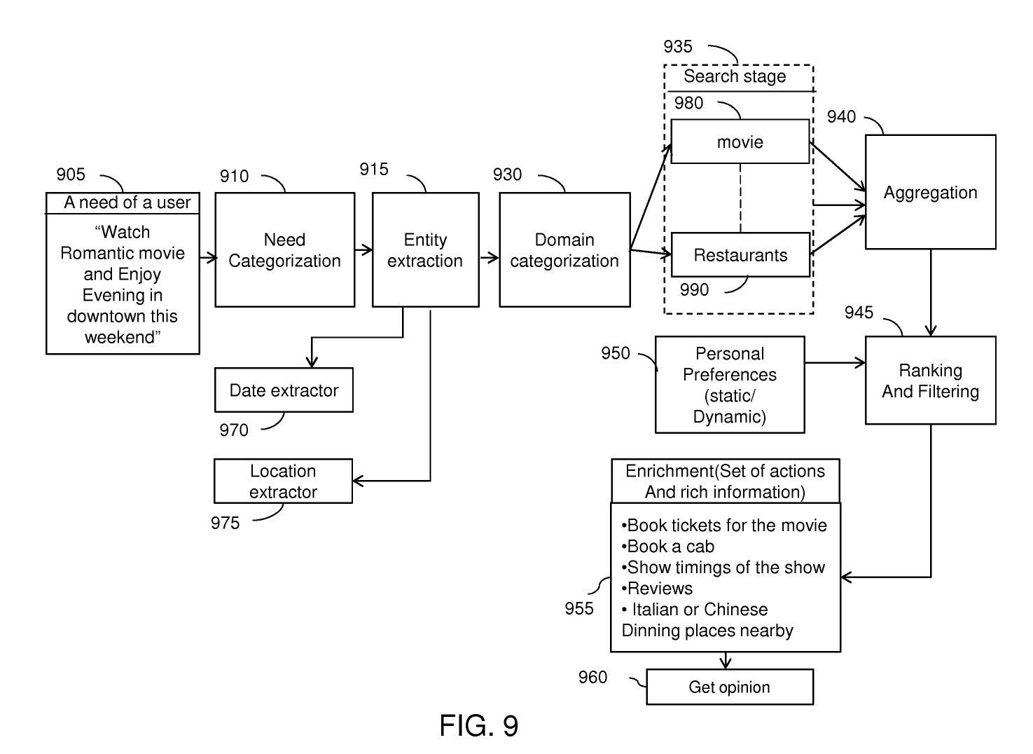

FIG. 9 is an exemplary illustration of relevant actions associated with an actionable recommendation corresponding to a need, in accordance with one embodiment of the present invention. The description of the FIG. 9 may be understood in conjunction with earlier description in this disclosure.

A user expresses the need in the form of a sentence “Watch Romantic movie and Enjoy Evening in downtown this weekend” as shown in the block 905. A system, such as the system 120, captures the need 905. Further, the system performs need categorization as shown in block 910. The need categorization is performed to identify the category associated with the need. The system identifies the need 905 as an informational need. Upon need categorization, a need processing system captures nouns “movie”, “downtown” and “weekend” included in the need 905. Further, the system also captures the verbs “watch” and “Enjoy” included in the need 905.

The system identifies the verb “watch” included in the need 905. Further, the system communicates with an entity extractor to extract entities from the need 915. The entity extractor 915 includes a date extractor 965 and a location extractor 970. The system communicates with the date extractor 965 to identify the date associated with the noun “weekend” included in the need 905. Further, the location extractor 970 may identify the location “downtown” included in the need 905.

Upon identifying the location and the date, the system performs a domain categorization technique as shown in block 930. The domain categorization technique may be performed that recognizes “watch” as an intent and “movie” as another entity hinting “movie” domain and hence identifies the domains as Entertainment, and Movies associated with the need 905. Restaurant can be associated with the enjoyment in the Entertainment domain for the food loving user. Various domains can be stored in a domain database. Further, separate databases can be maintained for each of the domains stored in one example a search stage 935. In one example, a movie domain 980 can be associated with a movie database. Multiple movies can be stored in the movie database. Another domain, a restaurant domain 990 may be associated with a restaurant database. Further, many other domains may be associated with the need.

Based on the verb “watch” included in the need 905, the system estimates that the intention of the user corresponding to the need 905 refers to watching a movie. Hence the need fulfillment system communicates, in the search stage 935, with the movie database and captures movies with genre as “romantic”. If a specific movie name was specified by the user in the need, for example, the words “jack goes boating” may included in the need 905. In that case, the system compares the words “jack goes boating” included in the need 905 and multiple movies included in the movie database. If a match between them is found, then the system concludes that the intention of the user corresponding to the need 905 refers to watching movie named “jack goes boating”.

Further, the aggregation module 940 aggregates the search results from various sources (as explained earlier in this document).

Further, the ranking and selection module 945, ranks the received recommendations I the movie and restaurant domain based various algorithms including rankings specified on the sources rankings, rankings based on the users preferences received from the user preference or personalization module 955. The user preferences may have been specified by the user or may be derived from the user's previous interactions. The user preferences in this example can identify the user's preference such as actors or actresses, or type of restaurant so that personalized recommendations can be provided to the user.

Further, the personal preferences 950 (personalized information) may be utilized for identifying the type of movie, rating, actors etc. implied in the intent of the need 905 by the user. Furthermore, the information corresponding to entity extraction 915 may be utilized for identifying the domain associated with the need. The personalized information may include user profile information.

Further, the system provides enriched information corresponding to the set of actionable recommendations as shown in block 955 responsive to the need 905. The actionable recommendations can be obtained by searching from various sources. Further opinions may be obtained from friends and experts as explained earlier in conjunction with FIG. 8. The enriched information 955 includes a set of actions and rich information corresponding to the user. For example, the enriched information may include, but is not limited to, providing web links for, identifying theatres located close to “downtown”, booking tickets for the movies for example “Jack goes to boating”, booking a cab to reach a particular theatre playing the movie “jack goes boating”, and reviews associated with the movie “jack goes boating”. Reviews may be obtained from various sources, for example, friends, experts, colleagues, specialized movie sites, social networking sites and the like. Reviews allow the user to make a decision while fulfilling the need.

Advantageously, the disclosed invention provides a small set of actionable recommendations responsive to the need of the user. Further, the one or more recommendations are provided based on relevance, preferences of the user, rich context and the like. Furthermore, the user may be enabled to perform one or more actions corresponding to a particular recommendation, responsive to the need. Further, the invention provides filtering of the recommendations to obtain relevant recommendations associated with the need, thereby reducing significant amount of time spent for searching relevant recommendations.

Further, the present invention allows the user to receive one or more recommendations from friends or experts through social networking sites. Furthermore, the friends or experts may provide opinions for one or more recommendations. Moreover, the invention allows the user to utilize the opinions provided by friends and experts for decision making thereby reducing considerable amount of time used for getting opinion. Additionally, the disclosed invention provides value added information that includes additional information associated with the recommendations.

Additionally, the present invention enables the user to provide feedback corresponding to the one or more recommendations. This enables the user to modify the need and to obtain the relevant results corresponding to the need.

The present invention may also be embodied in a computer program product for providing one or more recommendations responsive to the need. The computer program product may include a non-transitory computer usable medium having a set program instructions comprising a program code for providing one or more actionable recommendations relevant to the need of the user. The set of instructions may include various commands that instruct the processing machine to perform specific tasks such as providing the one or more actionable recommendations, aggregating one or more recommendations, ranking one or more recommendations, filtering the one or more recommendations and enabling the user to perform one or more actions corresponding to the one or more actionable recommendations responsive to the need of the user. The set of instructions may be in the form of a software program. Further, the software may be in the form of a collection of separate programs, a program module with a large program or a portion of a program module, as in the present invention. The software may also include modular programming in the form of object-oriented programming. The processing of input data by the processing machine may be in response to user commands, results of previous processing or a request made by another processing machine.

While the preferred embodiments of the invention have been illustrated and described, it will be clear that the invention is not limit to these embodiments only. Numerous modifications, changes, variations, substitutions and equivalents will be apparent to those skilled in the art without departing from the spirit and scope of the invention, as described in the claims.

The foregoing description sets forth numerous specific details to convey a thorough understanding of embodiments of the invention. However, it will be apparent to one skilled in the art that embodiments of the invention may be practiced without these specific details. Some well-known features are not described in detail in order to avoid obscuring the invention. Other variations and embodiments are possible in light of above teachings, and it is thus intended that the scope of invention not be limited by this Detailed Description, but only by the following Claims.

What is claimed is:

1. A method for providing one or more actionable recommendations relevant to a need of a user, the method comprising:
capturing the need of the user, the need captured by receiving a query from the user;
analyzing the need to determine one or more characteristics corresponding to the need of the user;
processing the need to generate one or more actionable recommendations, the need being processed based on at least one of the one or more characteristics;
providing the one or more actionable recommendations for enabling the user to perform one or more actions corresponding to at least one of the one or more actionable recommendations; and
enabling the user to provide feedback for the one or more actionable recommendations based on the need of the user,
wherein the feedback being processed to upgrade the one or more actionable recommendations corresponding to the need of the user.

2. The method of claim 1, wherein analyzing the need comprises performing at least one of:
parsing the need to determine entity data corresponding to the need, the entity data comprising data corresponding to one or more entities of the need;
identifying a type of the need and other information corresponding to the need of the user; and
determine one or more domains corresponding to the need.

3. The method of claim 1, wherein the one or more characteristics comprise at least one of entity data, a type of the need, intent of the user, preferences of the user, one or more tags, concept, and location information corresponding to the need of the user.

4. The method of claim 1, wherein processing the need comprises performing at least one of:
searching one or more information providers to obtain one or more sets of actionable recommendations therefrom, each set of the one or more sets of actionable recommendations being obtained from at least one of the one or more information providers;
aggregating at least one actionable recommendation of the each set of the actionable recommendations to form a list of aggregated recommendations;
ranking each actionable recommendation of the list of aggregated recommendations based on relevancy of the each actionable recommendation corresponding to the need; and
selecting the one or more recommendations from the list of aggregated recommendations based on the ranking.

5. The method of claim 1 further comprising processing the need for providing instant response prior to analyzing the need.

6. The method of claim 1, wherein the one or more actionable recommendations being provided with one or more options to enable the user to perform the one or more actions corresponding to at least one of the one or more actionable recommendations.

7. The method of claim 1 further comprising providing value added information corresponding to the one or more actionable recommendations.

8. The method of claim 1, wherein the feedback is provided to modify the need when the one or more actionable recommendations are not relevant to the need of the user.

9. The method of claim 1, wherein the feedback is processed further to generate a new set of actionable recommendations corresponding to the need of the user, the new set of actionable recommendations enable the user to perform one or more actions corresponding to the new set of actionable recommendations.

10. A method for providing one or more actionable recommendations relevant to a need of a user, the method comprising:
capturing the need of the user, the need captured by receiving a query from the user;
analyzing the need to determine one or more characteristics corresponding to the need of the user;
processing the need to generate one or more actionable recommendations, the need being processed based on at least one of the one or more characteristics; and
providing the one or more actionable recommendations for enabling the user to perform one or more actions corresponding to at least one of the one or more actionable recommendations.

11. The method of claim 10 further comprising enabling the user to provide feedback for the one or more actionable recommendations based on the need of the user, the feedback being processed to upgrade the one or more actionable recommendations corresponding to the need of the user.

12. The method of claim 10, wherein analyzing the need comprises performing at least one of:
parsing the need to determine entity data corresponding to the need, the entity data comprising data corresponding to one or more entities of the need;
identifying a type of the need and other information corresponding to the need of the user; and
determine one or more domains corresponding to the need.

13. The method of claim 10, wherein the one or more characteristics comprise at least one of entity data, a type of the need, intent of the user, preferences of the user, one or more tags, concept, and location information corresponding to the need of the user.

14. The method of claim 10, wherein processing the need comprises performing at least one of:
searching one or more information providers to obtain one or more sets of actionable recommendations therefrom, each set of the one or more sets of actionable recommendations being obtained from at least one of the one or more information providers;
aggregating at least one actionable recommendation of the each set of the actionable recommendations to form a list of aggregated recommendations;
ranking each actionable recommendation of the list of aggregated recommendations based on relevancy of the each actionable recommendation corresponding to the need; and
selecting the one or more recommendations from the list of aggregated recommendations based on ranking.

15. The method of claim 10 further comprising processing the need for providing instant response prior to analyzing the need.

16. The method of claim 10, wherein the one or more actionable recommendations being provided with one or more options to enable the user to perform the one or more actions corresponding to at least one of the one or more actionable recommendations.

17. The method of claim 10 further comprising providing value added information corresponding to the one or more actionable recommendations.

18. The method of claim 11, wherein the feedback is provided to modify the need when the one or more actionable recommendations are not relevant to the need of the user.

19. The method of claim 11, wherein the feedback is processed further to generate a new set of actionable recommendations corresponding to the need of the user, the new set of actionable recommendations enable the user to perform one or more actions corresponding to the new set of actionable recommendations.

20. A system for providing one or more actionable recommendations relevant to a need of a user, the system comprising:
a need capturing module for capturing the need of the user, the need captured by receiving a query from the user;
an analyzing module for analyzing the need to determine one or more characteristics corresponding to the need of the user;
a processing module to process the need to generate one or more actionable recommendations, the need being processed based on at least one of the one or more characteristics;
an output module configured to provide the one or more actionable recommendations to the user, the one or more actionable recommendations enable the user to perform one or more actions corresponding to at least one of the one or more actionable recommendations; and
a feedback module for enabling the user to provide feedback for the one or more actionable recommendations based on the need of the user,
wherein the processing module is capable of processing the feedback to upgrade the one or more actionable recommendations corresponding to the need of the user.

21. The system of claim 20, wherein the analyzing module comprising:
a parsing module to parse the need to determine entity data corresponding to the need, the entity data comprising data corresponding to one or more entities of the need;
an identification module to identify a type of the need and other information corresponding to the need of the user; and
a domain categorization module to determine one or more domains corresponding to the need.

22. The system of claim 20, wherein the one or more characteristics comprise at least one of entity data, a type of the need, intent of the user, preferences of the user, one or more tags, concept, and location information corresponding to the need of the user.

23. The system of claim 20, wherein processing module comprising:
a search module configured to search one or more information providers to obtain one or more sets of actionable recommendations therefrom, each set of the one or more sets of actionable recommendations being obtained from at least one of the one or more information providers;
an aggregation module configured to aggregate at least one recommendation of the each set of the actionable recommendations to form a list of aggregated recommendations; and
a ranking module to rank each actionable recommendation of the list of aggregated recommendations based on relevancy of the each actionable recommendation corresponding to the need,
wherein the ranking module further configured to select the one or more recommendations from the list of aggregated recommendations based on the rank.

24. The system of claim 20, wherein the output module further provides one or more options to enable the user to perform the one or more actions corresponding to at least one of the one or more actionable recommendations.

25. The system of claim 20, wherein the output module further provides value added information to the user, the value added information corresponding to the one or more actionable recommendations.

26. The system of claim 20, wherein the feedback module enables the user to modify the need when the one or more actionable recommendations are not relevant to the need of the user.

27. The system of claim 20, wherein the processing module is capable of processing the feedback to generate a new set of actionable recommendations corresponding to the need of the user, the new set of actionable recommendations enable the user to perform one or more actions corresponding to the new set of actionable recommendations.

28. A computer program product for use with a computer, the computer program product comprising a non-transitory computer usable medium having a computer readable program code embodied therein for providing one or more actionable recommendations relevant to a need of a user, the computer readable program code when executed performing a method comprising:
capturing the need of the user, the need captured by receiving a query from the user;
analyzing the need to determine one or more characteristics corresponding to the need of the user;
processing the need to generate one or more actionable recommendations, the need being processed based on at least one of the one or more characteristics;
providing the one or more actionable recommendations for enabling the user to perform one or more actions corresponding to at least one of the one or more actionable recommendations; and
enabling the user to provide feedback for the one or more actionable recommendations based on the need of the user,
wherein the feedback being processed to upgrade the one or more actionable recommendations corresponding to the need of the user.

29. The computer program product of claim 28, wherein analyzing the need comprises performing at least one of:
parsing the need to determine entity data corresponding to the need, the entity data comprising data corresponding to one or more entities of the need;
identifying a type of the need and other information corresponding to the need of the user; and
determine one or more domains corresponding to the need.

30. The computer program product of claim 28, wherein the one or more characteristics comprise at least one of entity data, a type of the need, intent of the user, preferences of the user, one or more tags, concept, and location information corresponding to the need of the user.

31. The computer program product of claim 28, wherein processing the need comprises performing at least one of:
searching one or more information providers to obtain one or more sets of actionable recommendations therefrom, each set of the one or more sets of actionable recommendations being obtained from at least one of the one or more information providers;
aggregating at least one actionable recommendation of the each set of the actionable recommendations to form a list of aggregated recommendations;
ranking each actionable recommendation of the list of aggregated recommendations based on relevancy of the each actionable recommendation corresponding to the need; and
selecting the one or more recommendations from the list of aggregated recommendations based on the ranking.

32. The computer program product of claim 28, wherein the computer program code further performs processing the need for providing instant response prior to analyzing the need.

33. The computer program product of claim 28, wherein the one or more actionable recommendations being provided with one or more options to enable the user to perform the one or more actions corresponding to at least one of the one or more actionable recommendations.

34. The computer program product of claim 28, wherein the computer program code further provides value added information corresponding to the one or more actionable recommendations.

35. The computer program product of claim 28, wherein the feedback is provided to modify the need when the one or more actionable recommendations are not relevant to the need of the user.

36. The computer program product of claim 28, wherein the feedback is processed further to generate a new set of actionable recommendations corresponding to the need of the user, the new set of actionable recommendations enable the user to perform one or more actions corresponding to the new set of actionable recommendations.
